(19) United States
(12) Patent Application Publication
(10) Pub. No.: US 2007/0290033 A1
(43) Pub. Date: Dec. 20, 2007

(54) PIN PAD FOR PREVENTING LEAKAGE OF CLIENT'S INFORMATION IN AN ATM AND METHOD FOR OPERATING THE SAME

(76) Inventors: Sang Hwan Kweon, Gunpo-si (KR); Sung Woo Kim, Seoul (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/762,396

(22) Filed: Jun. 13, 2007

(30) Foreign Application Priority Data
Jun. 15, 2006 (KR) 10-2006-0053821

(51) Int. Cl. G07F 19/00; G07D 11/00

(52) U.S. Cl. 235/379

(57) ABSTRACT

A method and an apparatus are provided for preventing the leakage of client information in banking automation equipment, such as an automated teller machine (ATM) or a cash dispenser (CD). More specifically, a method and an apparatus utilize infrared light-emitting elements that are generally attached on the periphery of the personal identification number (PIN) pad or a key pad. The infrared light is emitted at regular intervals when a user enters a password, thereby preventing a third party from capturing images of client password and financial transaction information using a camera. In addition, a peep-prevention shield can be installed on the periphery of the key (PIN) pad body to hide a motion of a user's hand, and more than one infrared light-emitting source can be mounted on an upper surface of the peep-prevention shield.

### BACKGROUND

Banking automation equipment is a financial service-related automation machine capable of supporting simple financial services, such as deposits or withdrawals, regardless of time and space, without the aid of a bank clerk. The banking automation equipment is configured to allow clients to process automated transactions by themselves, such as the withdrawal or deposit of cash (bills), using a medium such as a card or a passbook.

Recently, since most companies have adopted a five-day work week system, people frequently tend to use banking automation equipment, such as ATMs or CDs, instead of visiting a bank in person. Consequently, the installation of banking automation equipment has gradually expanded, and the number of banking automation equipment installed has increased more and more. Banking automation equipment is currently implemented such that it can be used in processing a variety of additional functions, as well as main services of the bank, and is continuously being developed to enhance bank competitiveness and client satisfaction.

In such an apparatus as banking automation equipment that prevents other people from illegally connecting to and using a banking system, only authorized users can normally operate the equipment. To this end, a password is given to each user, and a user is required to input the password before performing a financial processing function. It is confirmed whether the inputted password is identical to a previously registered password, and the next step of the function can be processed only if the two passwords are matched with each other.

However, while a user inputs a password in the currently used banking automation equipment, financial transaction information, including the client password, can be stolen through a pin-hole camera installed in the banking automation equipment or booth. Through the stolen password, as well as an illegally copied card or an illegally obtained card number, improper withdrawals or illegal credit transactions can be performed from a client's account.

In other countries, such crimes are extremely serious and increase year-by-year, and every effort is made to prevent these crimes. However, cases of practical use or application have not yet been reported.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, a method and an apparatus are directed to provide banking automation equipment that prevents the leakage of client information using infrared light-emitting elements attached on the periphery of the PIN pad of the banking automation equipment. The PIN pad is configured to operate the infrared light-emitting elements at regular intervals when a user enters a password so that photo images of a client password and financial transaction information cannot be correctly captured via a camera.

According to an aspect of the present invention, there is provided a method of preventing leakage of client information in banking automation equipment, which comprises the steps of receiving a selection of a financial transaction from a user when insertion of a passbook or card is recognized by a passbook/card recognition unit; operating an infrared light-emitting unit to emit infrared light using infrared light-emitting elements of a PIN pad; determining whether the infrared light-emitting elements operate normally by an infrared light sensor; receiving a password for the transaction from the user; informing a manager of the banking automation equipment of an abnormal operation thereof if it is determined that the infrared light-emitting elements operate abnormally; and stopping the operation of the infrared light-emitting elements and proceeding to conduct the transaction if the step of inputting a password is terminated.

In order to control the aforementioned steps of the present invention, there is provided banking automation equipment including a passbook/card recognition unit, a display unit, a printing unit, a check/cash deposit and withdrawal unit, a storage unit, and a communication unit. The banking automation equipment of the present invention comprises a key input unit, including a PIN pad provided with infrared light-emitting elements; an infrared light-emitting unit for amplifying infrared light and outputting the amplified light toward the PIN pad; an infrared light sensor for sensing the infrared light to determine whether the infrared light-emitting elements operate normally; and a control unit for controlling the aforementioned components and causing infrared light to be emitted from the infrared light-emitting unit, when a user inputs a password, to prevent an action of stealing a client password and financial transaction information using a camera.

Further, there is a PIN pad for preventing an action of stealing a client password and financial transaction information using a camera, which comprises a PIN pad body for encoding the user's password and performing a key operation; a peep-prevention shield installed on the periphery of the PIN pad body to hide a motion of a user's hand; and a plurality of infrared light-emitting elements mounted on an upper surface of the peep-prevention shield.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view showing an external appearance of a PIN pad for preventing the leakage of client information according to an embodiment of the present invention;

FIG. 2 is a perspective view showing an external appearance of banking automation equipment for preventing the leakage of client information according to an embodiment of the present invention;

FIG. 3 is a block diagram showing the configuration of the banking automation equipment for preventing the leakage of client information according to an embodiment of the present invention; and

FIG. 4 is a flowchart illustrating an operation process of the banking automation equipment for preventing the leakage of client information according to an embodiment of the present invention.

### DETAILED DESCRIPTION

Hereinafter, a preferred embodiment of the present invention will be described in more detail with reference to the accompanying drawings. However, the present invention is not limited to the preferred embodiment thereof set forth herein, but can be implemented in different forms. Rather, the preferred embodiment is merely provided to allow the present invention to be completely described herein and to fully convey the scope of the invention to those skilled in the art. In the drawings, like elements are designated by like reference numerals.

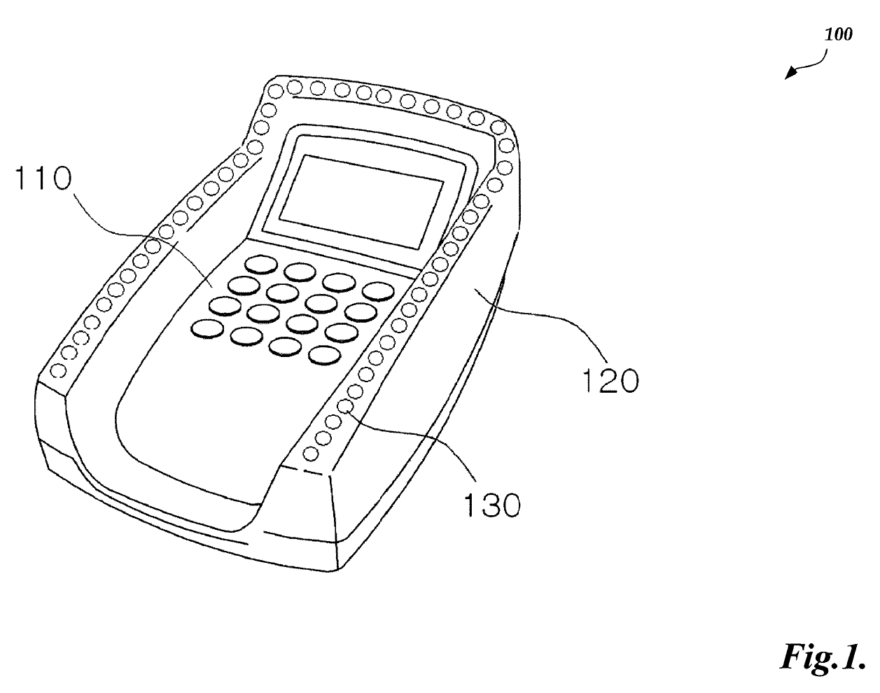

FIG. 1 is a perspective view 100 showing an external appearance of a PIN pad for preventing the leakage of client information according to an embodiment of the present invention.

Referring to FIG. 1, the PIN pad for preventing the leakage of client information using infrared light-emitting elements comprises a PIN pad body 110 for encoding a user's password and performing key operation, a peep-prevention shield 120 installed on the periphery of the PIN pad body 110, and the infrared light-emitting elements 130 mounted on an upper surface of the peep-prevention shield 120.

The PIN pad body 110 is an ordinary input device for receiving a user's key input and performs a variety of functions related to input operations, such as a function of encoding a password or transmitting input data, if a user inputs the password when user authentication/confirmation is required or the user inputs transaction information, such as a payment amount, in a financial transaction or the like through the buttons of the keypad provided on the PIN pad body 110.

The peep-prevention shield 120 is made of a material through which infrared light cannot pass and is vertically installed along the periphery of the PIN pad body 110. The peep-prevention shield 120 serves to hide a motion of a user's hand, which is used to input the password, so that a camera cannot take a picture of the motion.

In addition, the peep-prevention shield 120 functions as a portion on which the infrared light-emitting elements 130 are installed. Dozens of fixing holes are formed on the upper surface of the peep-prevention shield 120 so that the infrared light-emitting elements 130 can be fixed into the respective fixing holes. That is, the infrared light-emitting elements 130 are configured to receive amplified signals and electric power from a control substrate in the equipment through the respective fixing holes.

Each of the infrared light-emitting elements 130 emits infrared light at regular intervals, like strobe light, to allow the camera not to automatically adjust luminance and thus to prevent the leakage of a password. Since a human being cannot sense infrared light with his/her naked eyes, the infrared light does not affect the user. However, since a pin-hole camera or film camera used in the crime senses widely an infrared light band, a flash of the camera is difficult to automatically adjust or change the luminance of the camera due to the influence of the infrared light. Accordingly, a lighting interval of the infrared light-emitting element 130 is preferably set to be faster than the speed of the flash in an ordinary camera.

Further, a diffusion-type infrared light-emitting diode array with low electrode contact resistance and high light-emitting efficiency is preferably used as the infrared light-emitting element 130. The diffusion-type infrared light-emitting diode has a light-emitting efficiency, which is 20% higher when the light travels straight and is 80% higher when the light diffuses, as compared with that of a general light-emitting diode where lights are converged on the center and travel only in a forward direction. Furthermore, since the diffusion-type infrared light-emitting diode is small in size and thus can be properly arranged in parallel or series, it is easy to increase the intensity of a light source. Moreover, since the lifespan of the infrared light-emitting diode is semi-permanent, there is no inconvenience of replacing electric bulbs, which is inevitable when an incandescent lamp or halogen bar lamp is employed.

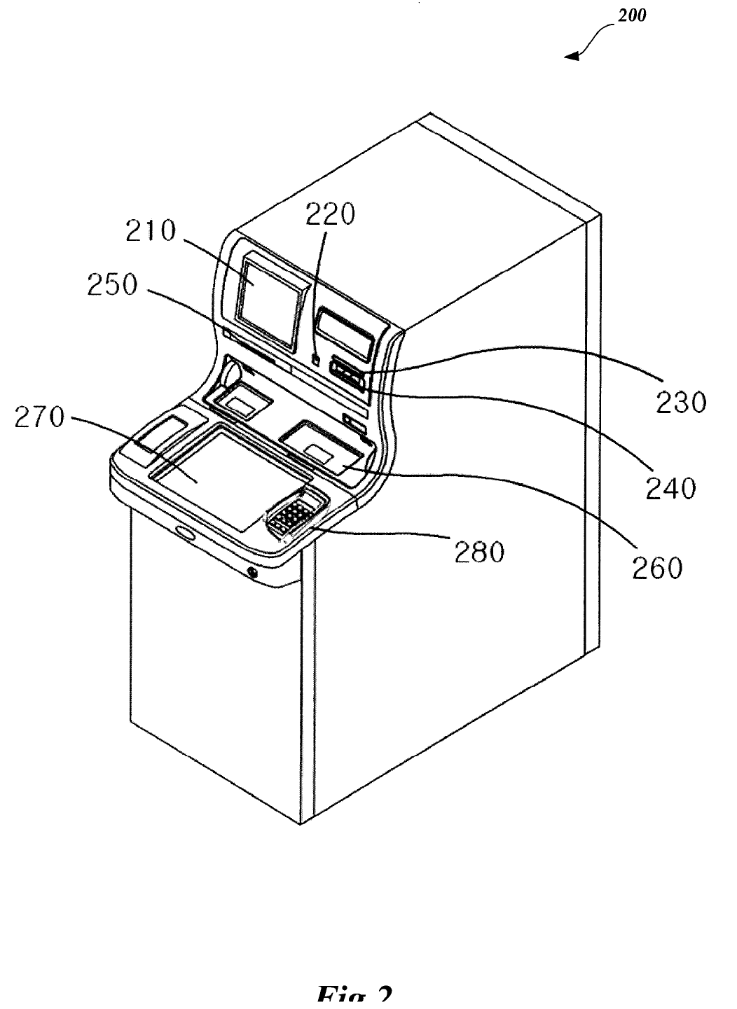

FIG. 2 is a perspective view 200 showing an external appearance of banking automation equipment for preventing the leakage of client information according to an embodiment of the present invention.

Referring to FIG. 2, the main body of the banking automation equipment according to the present invention includes an infrared light sensor 220, a card slot 230, and a transaction details discharge slot 240 on the right side of a liquid crystal display (LCD) unit 210; and a passbook slot 250, a cash deposit and withdrawal unit 260, a display unit 270, and a PIN pad 280 for preventing the leakage of client information using the infrared light-emitting elements, which is the core of the present invention, on the lower side of the LCD unit 210.

In the banking automation equipment described above, the infrared light-emitting elements of the PIN pad 280 for preventing the leakage of client information operate at regular intervals similar to a strobe light before a user inputs his/her password for a financial transaction, and the infrared light sensor 220 senses infrared light to determine whether the infrared light-emitting elements operate normally. If the infrared light-emitting elements operate normally, the user is allowed to input the password. On the other hand, if the infrared light-emitting elements operate abnormally, a manager of the banking automation equipment is informed in order to smoothly operate the PIN pad for preventing the leakage of client information, thereby to safely manage the user's password.

In the present invention, it is illustrated that the infrared light sensor 220 is placed at the uppercenter of the banking automation machine, but the present invention is not limited thereto. It is apparent that the infrared light sensor can be installed at any place in the neighborhood of the banking automation equipment, as well as in the banking automation equipment, so long as the infrared light sensor can sense the infrared light emitted from the PIN pad 280 for preventing the leakage of client information.

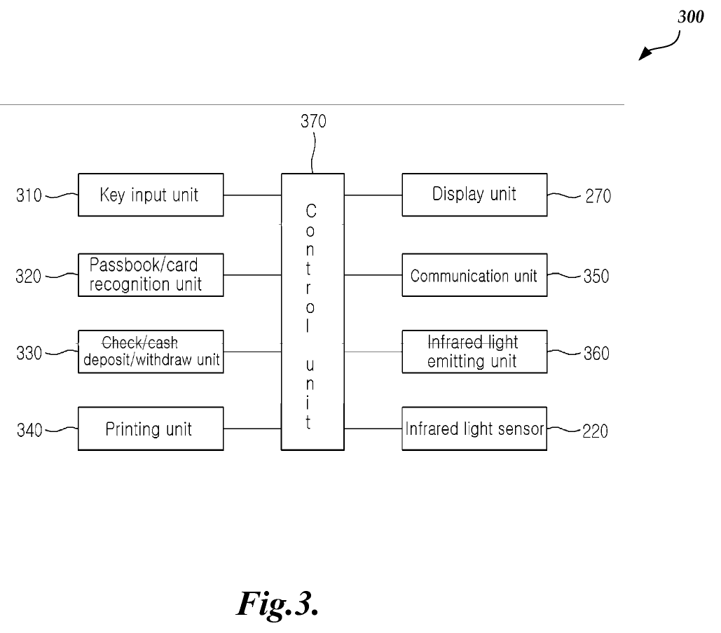

FIG. 3 is a block diagram showing the configuration of the banking automation equipment for preventing the leakage of client information according to an embodiment of the present invention.

Referring to FIG. 3, the banking automation equipment 300 comprises a key input unit 310, a passbook/card recognition unit 320, a check/cash deposit and withdrawal unit 330, a printing unit 340, a storage unit (not shown), a display unit 270, a communication unit 350, and a control unit 370 in order to perform basic financial transactions. In addition, the banking automation equipment further comprises an infrared light-emitting unit 360 for lighting up the infrared light-emitting elements according to the present invention and an infrared light sensor 220 for sensing the infrared light.

The key input unit 310 includes a plurality of buttons for receiving basic input in order to perform transactions and converts user's input information into electrical signals to transmit the converted signals to the control unit 370. The key input unit 310 includes a PIN pad 280. If the PIN pad 280 receives a key input, the received key input is converted into electrical signals and then transmitted to the control unit 370.

The infrared light-emitting unit 360 emits infrared light and includes an oscillator (not shown) for receiving oscillation signals from the control unit 370 and generating electrical vibrations to emit a certain amount of infrared light, and an amplifier (not shown) for amplifying the infrared light outputted from the oscillator.

If the control unit 370 applies an oscillation signal to the oscillator, the oscillator generates a certain amount of infrared light. Subsequently, as the amplifier amplifies the generated infrared light, the infrared light-emitting elements 130 of the PIN pad emit the amplified infrared light.

The infrared light sensor 220 senses absolute physical quantities of the infrared light generated from the PIN pad 280 to determine whether the infrared light-emitting elements 130 of the PIN pad 280 operate normally.

Generally, there are a variety of elements that can detect the absolute physical quantities of infrared light, and it is preferable to use a focal plane array (FPA)-type infrared light-sensing element.

The FPA-type infrared light-sensing element comprises an optical lens, a focal plane array connected to the optical lens, and a signal processor connected to the focal plane array. The optical lens concentrates infrared light signals from an object image onto a surface of the focal plane array. The focal plane array has a plurality of detectors and converts the received infrared light signals into electrical signals corresponding thereto. The signal processor receives the electrical signals outputted from the focal plane array and converts the electrical signals into signals suitable for transmission to the control unit 370.

Accordingly, if a signal indicating that the infrared light sensor 220 has sensed infrared light is sent to the control unit, the control unit 370 determines that the PIN pad 280 for preventing the leakage of client information using the infrared light-emitting elements 130 operates normally, and the user is then guided to input the password.

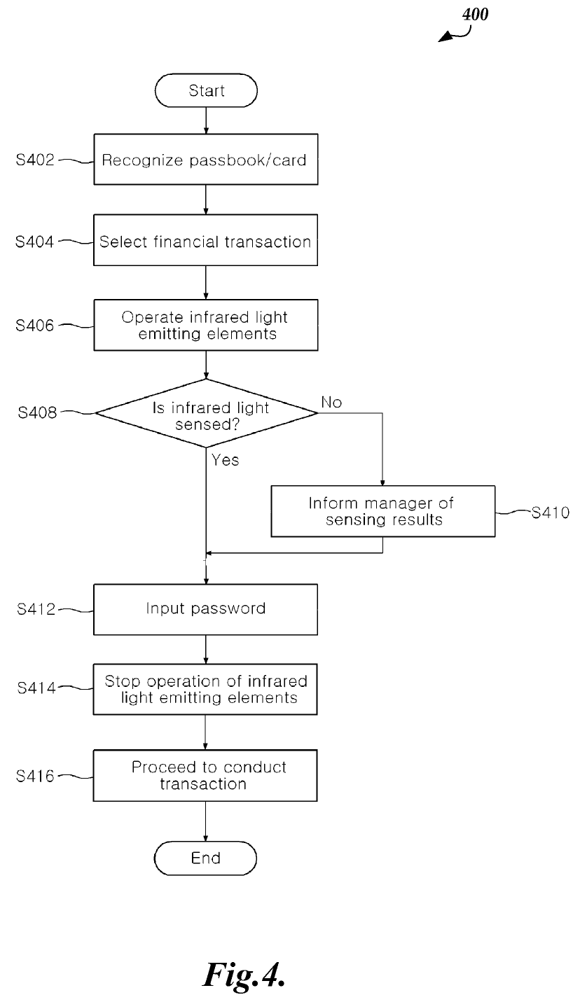

FIG. 4 is a flowchart 400 illustrating an operation process of the banking automation equipment for preventing the leakage of client information according to an embodiment of the present invention.

First, a user inserts a passbook or a card into the banking automation equipment, and the passbook/card recognition unit 320 recognizes the passbook or card (step S402). Then, the user selects a financial transaction through the key input unit 310 while confirming the contents displayed on the display unit (step S404).

If a transaction is selected, the control unit 370 actuates the infrared light-emitting elements 130 to generate infrared light (step S406). That is, if an oscillation signal is applied to the oscillator of the infrared light-emitting unit 360, the oscillator generates a certain amount of infrared light. Then, the amplifier causes the generated infrared light to be amplified and the amplified infrared light to be emitted through the infrared light-emitting elements 130 of the PIN pad.

If infrared light is emitted through the infrared light-emitting elements 130, the infrared light sensor 220 senses the infrared light to determine whether the infrared light-emitting elements 130 of the PIN pad operate normally (step S408). If it is determined that the infrared light-emitting elements operate normally, the user inputs a password according to the directions for use (step S412). If it is determined that the infrared light-emitting elements operate abnormally, a manager of the banking automation equipment is informed through the communication unit (step S410), and then the user inputs a password (step S412).

If the input of the password is completed, the operation of the infrared light-emitting elements 130 of the PIN pad is stopped (step S414), and the control unit 370 allows the banking automation equipment to connect with a host computer of a bank through the communication unit 350 such that the financial transaction can be performed while the relevant data are exchanged between the banking automation equipment and the host computer (step S416).

Although the present invention has been described and illustrated in connection with the specific preferred embodiment, the present invention is not limited thereto and is defined by the appended claims. Therefore, it will be understood by those skilled in the art that various modifications and changes can be made thereto without departing from the spirit and scope of the present invention defined by the appended claims.

According to the present invention as described above, there is an advantage in that an apparatus for preventing the leakage of client information using infrared light-emitting elements is attached on the periphery of the PIN pad of the banking automation equipment to operate the infrared light-emitting element at regular intervals when a user enters a password, so that damage due to actions of stealing a client password and financial transaction information using a camera can be prevented or minimized.

Further, the reliability of financial transactions can be enhanced due to reinforced security of the banking automation equipment, and an effect of highlighting the image of a differentiated financial institute can be achieved.

While illustrative embodiments have been illustrated and described, it will be appreciated that various changes can be made therein without departing from the spirit and scope of the invention.

What is claimed is:

1. A personal identification number (PIN) pad for preventing an action of stealing a client password and financial transaction information using a camera, the PIN pad comprising:
a PIN pad body for encoding the user's password and performing a key operation;
a peep-prevention shield installed on the periphery of the PIN pad body to hide a motion of a user's hand; and
a plurality of infrared light-emitting elements mounted on an upper surface of the peep-prevention shield.

2. The PIN pad as claimed in claim 1, wherein a diffusion-type infrared light-emitting diode array with low electrode contact resistance and high light-emitting efficiency is installed as the infrared light-emitting elements.

3. The PIN pad as claimed in claim 2, wherein the infrared light-emitting diode operates to be lit up at predetermined regular intervals.

4. The PIN pad as claimed in claim 3, wherein the operating interval is shorter than a flashing rate of an automatic flash of a camera.

5. Banking automation equipment including a passbook/card recognition unit for recognizing a passbook or card inserted for a general transaction, a display unit for displaying transaction descriptions on a screen, a printing unit for printing the transaction descriptions on the passbook and printing/outputting transaction details, a check/cash deposit and withdrawal unit for depositing and withdrawing a check/cash, a storage unit for storing a program for controlling the banking automation equipment and transaction descriptions of an automated teller machine (ATM), and a communication unit for exchanging information with a host computer of a bank, the banking automation equipment comprising:
a key input unit including a PIN pad provided with infrared light-emitting elements;
an infrared light-emitting unit for amplifying infrared light and outputting the amplified light toward the PIN pad;
an infrared light sensor for sensing the infrared light to determine whether the infrared light-emitting elements operate normally; and
a control unit for controlling the aforementioned components and causing infrared light to be emitted from the infrared light-emitting unit, when a user inputs a password, to prevent an action of stealing a client password and financial transaction information using a camera.

6. The equipment as claimed in claim 5, wherein the infrared light-emitting unit includes an oscillator for generating electrical vibrations to output infrared light, and an amplifier for amplifying the infrared light outputted from the oscillator.

7. The equipment as claimed in claim 6, wherein the infrared light sensor senses the infrared light using a focal plane array (FPA) type infrared light-sensing element.

8. A method of preventing leakage of client information in banking automation equipment provided with an infrared light-emitting unit, an infrared light sensor, and a PIN pad using infrared light-emitting elements, the method comprising the steps of:
receiving a selection of a financial transaction from a user when insertion of a passbook or card is recognized by a passbook/card recognition unit;
operating the infrared light-emitting unit to emit infrared light using the infrared light-emitting elements of the PIN pad;
determining whether the infrared light-emitting elements operate normally by the infrared light sensor;
receiving a password for the transaction from the user;
informing a manager of the banking automation equipment of an abnormal operation thereof if it is determined that the infrared light-emitting elements operate abnormally; and
stopping the operation of the infrared light-emitting elements and proceeding to conduct the transaction if the step of inputting a password is terminated.
